(19) United States
(12) Patent Application Publication
(10) Pub. No.: US 2016/0369215 A1
(43) Pub. Date: Dec. 22, 2016

(54) Tank Connection

(71) Applicant: KRONES AG, Neutraubling (DE)

(72) Inventors: Tobias Thiel, Neutraubling (DE); Horst-Hermann Reuss, Neutraubling (DE); Hans Paintner, Neutraubling (DE); Detlef Stenger, Neutraubling (DE)

(21) Appl. No.: 14/901,419

(22) PCT Filed: Jul. 4, 2014
(86) PCT No.: PCT/EP2014/064308

§ 371 Date: Dec. 28, 2015

(30) Foreign Application Priority Data
Jul. 29, 2013 (DE) 102013214729.5

(51) Int. Cl. C12C 11/00; B67D 7/78; B08B 9/032; B67D 7/02

(52) U.S. Cl. CPC C12C 11/006; B67D 7/0294; B67D 7/78; B08B 9/0321

(57) ABSTRACT

A tank connection system including a plurality of tanks, each of the plurality of tanks has a tank outlet, to which a line piece is connected by a first valve, which line piece has a first hose connection point at a first end and a second hose connection point at a second end, and a plurality of lines, which each have two additional hose connection points, which can be cut off from each other by a second valve or separated from each other by a line disconnection.

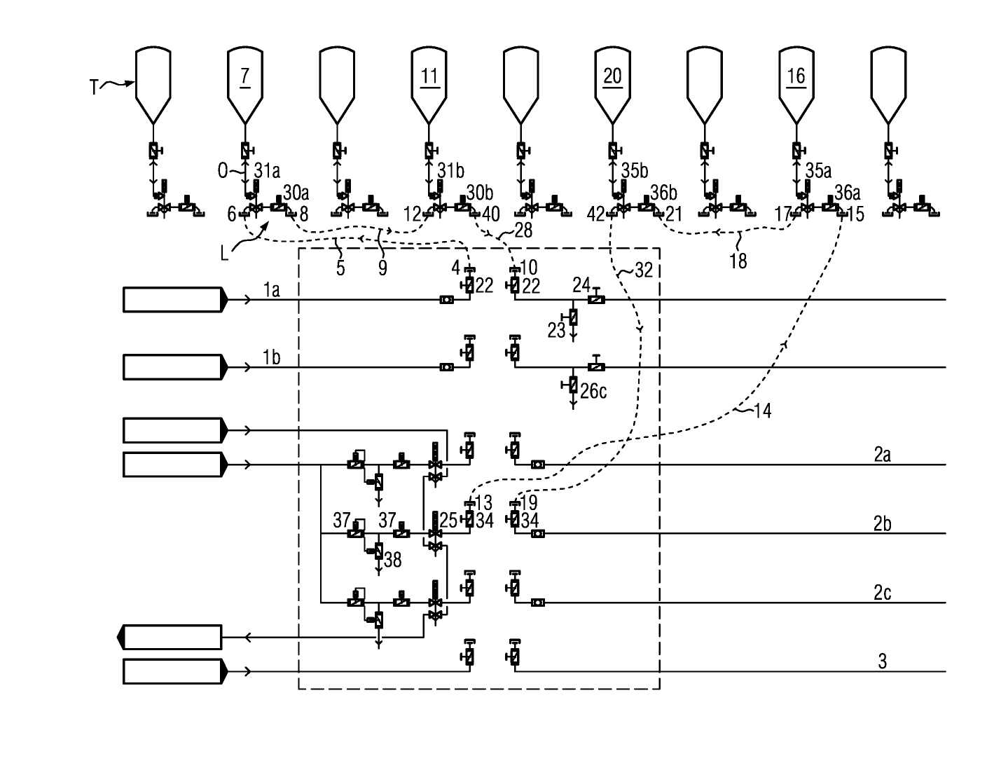

### CROSS-REFERENCE TO RELATED APPLICATION

The present application is the US National Phase of International Patent Application No. PCT/EP2014/064308, filed Jul. 4, 2014, which application claims priority to German Patent Application No. 102013214729.5, filed Jul. 29, 2013. The priority application, DE 102013214729.5, is hereby incorporated by reference.

### FIELD OF THE INVENTION

The present invention relates to a connection of tanks, particularly of fermentation tanks and/or storage tanks at a brewery.

### BACKGROUND OF THE INVENTION

In the beer brewing process, the finished wort is put into the fermentation and storage cellar after the brewhouse process. Thus, the beer is stored in fermentation and storage tanks. For example, cylindroconical fermentation and storage tanks are often used. The cylindroconical fermentation and storage tanks are containers that are closed/open towards the environment, in which the fermentation or maturation/storage of the beer occurs. Fermentation and maturation/storage can take place in the same tank or in separate tanks. In the latter case, the intermediate product is transferred by a pump (for example a transfer of the green beer through a hose). The cylindroconical fermentation and storage tanks are generally filled from below and emptied towards the bottom. Filling from below and emptying towards the bottom requires the cylindroconical fermentation and storage tanks to be connected to several pipes, particularly with a feed line for the wort, a discharge pipe for the harvested yeast, a discharge pipe for the beer and a feed and discharge line for the individual CIP (cleaning-in-place) fluids. Therefore, it is important that these connections will be provided without contamination and without any inflow of oxygen.

For the connection of the fermentation and storage tanks to filling pipes and/or emptying pipes, fixed connection tubes and mobile hose connections are known in the state of the art. In the fixed connection tube, automated leakage-proof valves or swing bends in connection with locking flaps that can be removed by means of screw joints are for example used for leakage-proof locking of different pipes. Manually relocatable swing bends can thereby be installed as a function of the desired process management to connect the relevant pipes. The connection of the swing bends typically occurs via tank inflow and/or outflow lines that are usually open towards the tank and that are cleaned together with the tank. As part of the hose connection, hoses are used manually to connect the tank outflow and/or inflow lines with the relevant pipes as required.

The swing bends and auxiliary fittings for the hose connection (for example arches, coupler elements or locking taps) are typically stored in basins filled with a disinfection agent prior to their use and have to be taken out of the basins before they are used for a filling or emptying process and installed on the relevant contact areas. This comes with the risk of contamination of the swing bends and hoses during handling. In addition, the connection will have to be vented by means of water, preferably with de-gassed water, if the product to be transported may not be exposed to oxygen. In general, the connection paths from and to the tanks traditionally have to be pushed out in a complex way (water through product and vice versa) by means of activating valves in due time and in a specific order. The connection through swing bends and relatively long tank inflow and/or tank outflow lines (tap lines) is not advantageous in this case as the formation of different quality-reducing metabolic products in the pipe is favored by the small-scale material exchange between the pipe and the tank.

Therefore, also swing bend and double-seat valve connections of the filling and/or emptying pipes to so-called tank loops are provided as an alternative to the connection of swing bends to long tank inflow and/or outflow lines. The start and/or the end of such a tank line is thereby connected to respectively one swing bend or double-seat valve with the relevant filling and/or emptying pipe. The tank line is for example connected to the tank through a double-seat valve, which is located directly on the tank. This allows for the realization of short tank inflow and/or outflow lines. There can be one or also several tanks in one tank line. When grouping tanks in tank lines, the order in which the tanks are to be filled is subject to certain rules in order to guarantee an effective use of the available overall tank capacity. For example, it has to be ensured that no tank will have to be filled within a tank group through its loop while product is already being extracted from another tank via the same loop, for instance by means of a hose. Such a double loading would lead to unnecessary waiting times and/or deviations from the production plan. In order to prevent such double loadings and to ensure an effective use of the tank capacities, a defined tank loading management system is consequently necessary. In small and assortment breweries, such a tank loading management system is often too complex and therefore not feasible and/or not efficient. The fixed loops do not allow for arbitrary flexibility with regard to the order of the operation of the available tanks.

Consequently, the present invention is based on the purpose of providing a connection of tanks, particularly of fermentation tanks and/or storage tanks in a brewery, which ensures maximum flexibility at a high hygienic standard and minimial manual interventions with the associated contamination risk of the connections at a concurrently increased degree of automation.

### DESCRIPTION OF THE INVENTION

The abovementioned problem is solved by a tank connection system including several tanks, each of which has a tank outlet (and/or inlet) that is connected to a duct element through a first valve (particularly an automated leakage-proof valve), that has a first hose junction at a first end and a second hose junction at a second end. The connection of the tank outlet to the duct element is consequently located between the ends and hence between the hose junctions. Furthermore, the tank connection system comprises several pipes that have respectively two further hose junctions that can be shut off from each other through a second valve (shut-off valve) or that are disconnected from each other through a line break. Through the line break, a duct is physically divided in two duct parts. One of the two further hose junctions is located on one of the duct parts that are physically separated from each other, and the other one of the two further hose junctions is situated on the other one of the duct parts that are physically separated from each other. The system can be a tank connection system for a brewery in which the tanks are used for fermentation, maturation and storage for beer and/or intermediate beer products. The tank outlet is used both to empty as well as to fill the tank; the terms “tank outlet” and “tank inlet” are used as synonyms in this context.

In the same way as fixed tube systems with tank lines, short tank outlets can be set up in or-der to minimize the formation risk of quality-reducing materials. The hoses can be used flexibly to build connections for a defined desired sequence of processes such as rinsing, filling and cleaning without the need to disconnect or newly establish the respective connections after they have been set up as is the case in conventional hose or swing bend cellars. The hose connections required for a program sequence of cleaning, filling and emptying processes are set up; then, such a program can run automatically without the need for manual reconfiguration of the hose connections (see also detailed description below).

Compared to conventional tank lines with fixed tubes (loops), the tank connection system according to the invention ensures maximum flexibility with regard to the order in which the connected tanks are used as they can be grouped flexibly for a defined program sequence (e.g. of rinsing, filling, cleaning) by means of the hose junctions. In addition, only the connections that are required within a given period (work shift) for one or several program sequence(s) can also be set up.

For the automated control of individual steps, i.e. the discharge process (particularly for the separation between the water and the product phase) within a program, e.g. cleaning (especially of the tanks), filling or emptying (of the tanks), one of the two hose junctions on the tank can be equipped with an (automated) shut-off valve. The plurality of lines can comprise at least one filling pipe to fill at least one of the plurality of tanks and at least one emptying pipe to empty at least one of the plurality of tanks.

According to a further embodiment, a combination of a drain valve (on gully) and a block valve (to lock the extension line, for example to the CIP return pipe) is to be installed in each downstream filling pipe from (to) the downstream hose junction for the discharge for example of water. The downstream hose junction of a filling pipe is defined by the inflow side of two further hose junctions of the filling pipe; from the upstream hose junctions, i.e. the discharge side of the two further hose junctions of the filling pipe, a tank is filled through a hose that is connected accordingly.

A water discharge and/or a venting process of ducts and hoses can in particular occur automatically if each discharge line is connected to a water pipe by means of a particularly automated valve that is located upstream of (ahead of) the upstream hose junction. The upstream hose junction of the emptying pipe is formed by the discharge side of the two further hose junctions of the emptying pipe; a tank is emptied through a respectively connected hose via the downstream hose junction, i.e. the inflow side of the two further hose junctions of the emptying pipe.

According to another further embodiment, each emptying pipe is connected upstream of the upstream hose junction with a cleaning-in-place (CIP) system through a particularly automated and leakage-proof third valve. Therefore, a CIP process can run automatically for lines including the integrated hoses without the need to dismantle or to re-install hoses before or after in the course of a program sequence.

In the examples described above, a first group of the plurality of tanks can be connected to a filling pipe through a plurality of first hoses and/or a second group of the plurality of tanks can be connected through a plurality of second hoses to an emptying pipe via the relevant hose junctions. Groups of tanks are formed through specific selected hose junctions. In particular, a group of empty tanks can be planned as a target tank to be filled and a further group of filled source tanks can be provided as a source tank group for emptying. Filling and emptying of the respective tanks as well as discharging of lines and hoses with all preparatory and subsequent programs such as rinsing or cleaning can only be implemented after establishing the relevant hose connections in a program sequence without the need of replacing a hose.

The issue mentioned above is also solved by a process for filling and/or emptying of tanks that each have a tank outlet, which is connected to a duct element between two hose junctions of said tank outlet through a valve, whereby the process comprises the following steps:

a) Connection of a group of target tanks of the tanks to at least one filling pipe that has two filling pipe hose junctions, which can be shut off from each other by a second valve or that are disconnected from each other by a line break, by means of a first plurality of hoses,

whereby the connection comprises the linkage of one of the two hose junctions on the tank to one of the two filling pipe hose junctions (and, where appropriate, also of the second hose junctions on the tank to the second filling pipe hose junctions) by means of hoses of the first plurality of hoses;

and/or b) connection of a group of source tanks of the tanks to at least one emptying pipe that comprises two emptying pipe hose junctions, which can be shut off from each other by means of a second valve or that are disconnected from each other through a line break, by means of a second plurality of hoses;

whereby the connection comprises the linkage of one of the two hose junctions to one of the two emptying pipe hose junctions by means of hoses of the second plurality of hoses;

and after finishing the connection of the group of target tanks and/or the group of source tanks

c) Filling of the group of target tanks with a product and/or emptying of the group of source tanks without disconnecting a hose connection.

The group of target tanks and the group of source tanks can comprise respectively one or several tanks.

After finishing the connections of the respective tanks, a filling and/or emptying process can take place without having to disconnect any of the hose connections established by the hoses of the first and/or second plurality of hoses. Hence, there is no risk of contamination as a result of handling the hoses. The connection by means of the hose junctions according to a desired process sequence of emptying and/or filling of tanks occurs with maximum flexibility. Emptying and/or filling of tanks can in particular comprise the transfer of a product from a source tank to a target tank through a hose.

The connection of the target tanks can comprise the linkage of the target tanks among each other by means of hoses from the first plurality of hoses and/or the connection of the source tanks can comprise the linkage of the source tanks among each other by means of hoses from the second plurality of hoses. The tanks interconnected in this way can represent tanks of a group.

According to a further embodiment, the process continues to comprise, after finishing the connection of the group of target tanks and/or the group of source tanks prior to filling and emptying, the rinsing process with water, particularly with de-gassed water for the purpose of venting, of the at least one filling pipe and/or the at least one emptying pipe and/or of hoses of the first plurality of hoses and/or the second plurality of hoses, without disconnecting a hose connection (i.e. without the need to disconnect one of the hose connections established by the hoses of the first and/or second plurality of hoses). Alternatively or in addition to the rising process with water, a disinfection, a sterilization or a cleaning process can take place.

Furthermore, the process can comprise the discharge of the water from the at least one filling pipe and/or the at least one emptying pipe and/or of hoses of the first plurality of hoses and/or the second plurality of hoses after the end of the rinsing process, without disconnecting a hose connection.

The abovementioned examples of the process can further comprise the cleaning step of the at least one filling pipe and/or of the at least one emptying pipe and/or of hoses of the first plurality of hoses and/or the second plurality of hoses after finishing the filling and/or the emptying process by means of a connected cleaning-in-place system (CIP), without disconnecting a hose connection. The CIP system can be connected as described above in the context of the connection system.

Furthermore, it is possible to clean a tank or several of the tanks in a successive way, by means of the connected cleaning-in-place system without disconnecting a hose connection, after finishing the filling and/or emptying processes.

The further embodiments of the connection system according to the invention described above can be used in all examples mentioned above for the process according to the invention.

In the following, embodiments of a system according to the invention shall be described with reference to the drawing. The described embodiments shall be regarded as merely illustrative and non-exhaustive in all respects, and different combinations of the indicated characteristics are comprised by the invention.

### DESCRIPTION OF THE DRAWING

The drawing figure shows a connection system and/or a part of a hose cellar of a brewery according to an example of the invention with tanks, filling pipe and emptying pipes as well as hoses to link the tanks to the filling pipes and emptying pipes.

### DETAILED DESCRIPTION OF THE PREFERRED EMBODIMENT

The connection system illustrated in the drawing figure comprises a plurality of storage or fermentation tanks T, among others the tanks 7, 11, 16 and 20. Each of the tanks has a relatively short tank outlet and/or inlet 0. In the following, the term “tank outlet” shall be constantly used. However, it is clear that this tank outlet works as an inlet during the filling process of the tank. Valves 31a such as automatically switchable valves, for example in form of double-seat valves, are to be installed in the tank outlets 0 for the connection with a relatively short duct element L as shown in the drawing figure. The duct element L carries hose junctions 6 and/or 8 on both ends. On the hose junction 8 there is a further valve 30a, for example an automated disc valve. Due to the valve 30a, discharge processes can run automatically when the tank 7 is connected both as a source tank and as a target tank.

Moreover, filling pipes 1a, 1b and emptying pipes 2a, 2b, 2c are to be installed. For example, wort or green beer (e.g. Schlaucher beer (beer to be transferred from a fermentation tank to a storage tank) and/or partially fermented, not yet matured beer) can be filled in the tanks T. Through the discharge lines 2a, 2b, for example yeast can be led to the yeast cellar or turbid beer can be fed to a filter system out of a tank T. Each filling pipe 1a, 1b has hose junctions 4, 10 with shut-off valves 22 and each emptying pipe 2a, 2b also has hose junctions 13, 19 with shut-off valves 34. The tanks T and the filling pipes 1a, 1b and/or the emptying pipes 2a, 2b can be interconnected by means of the hose junctions through hoses 5, 9, 14 and 32. Tanks that are used as source tanks can be connected to a CIP return flow line 3 by means of hoses and cleaned.

The hose junctions 4, 10 are respectively separated from each other by a shut-off valve or a line break. In the filling pipes 1a, 1b, respectively a combination of a drain valve (23) and a block valve (24) for the discharge of water is to be installed behind the second hose junction 10 (on the right in the drawing figure). In the emptying pipes 2a, 2b, 2c, respectively one automated valve 25, for example in the form of a double-seat valve, and a CIP connection 37, 38 as shown in the drawing figure, for example as a combination of three, are to be installed ahead of the first hose junction 13 (on the left in the drawing figure). A water pipe is connected through the automated valve 25 so that a discharge by means of water and/or a venting process can occur automatically.

In the configuration shown in the drawing figure, the tanks 7 and 11 are target tanks and the tanks 16 and 20 are source tanks. A target tank 7 that is ready to be filled is connected through the establishment a hose connection 5 from the outlet side (left side) of the hose junction 4 of the filling pipe 1a to the junction 6 of the duct element L of the target tank 7 that is not equipped with the shut-off valve 30a. A further hose 9 is connected to the junction 8 that is equipped with the shut-off valve 30a. If only the tank 7 is to be connected, a hose 9 shall be connected to the inlet side (right side) of the hose junction 10 of the filling pipe 1a. If, in contrast, the target tank 11 is to be connected, the hose 9 shall be connected to the junction 12 of the duct element L of the target tank 11 that is not equipped with the shut-off valve 30b. In this case, a further hose 28 is connected to the junction 40 that is equipped with the shut-off valve 30b and linked to the inlet side of the hose coupling 10 of the filling pipe 1a.

A source tank 16 intended for emptying is connected by means of establishing a hose connection 14 between the junction 15, that is equipped with the shut-off valve 36a, and the outlet side (left side) 13 of the hose junction of the emptying pipe 2b. A further hose 18, which is connected to the inlet side 19 (right side) of the emptying pipe 2b if only the connection of the source tank 16 is desired, is connected to the hose junction 17. If also a further source tank 20 is to be connected, the hose 18 shall be connected to the junction 21 of the duct element of the tank 20 that is equipped with the valve 36b. Another hose connection 32 is established between the junction 42 of the duct element of the tank 20 that is not equipped with the valve 36b and the inlet side 19 of the hose junction of the emptying pipe.

Of course, further tanks T can be connected in the same way, be it as a source tank or as a target tank. In general, simple and fast installation with the possibility of making any upgrade without downtimes can be achieved by means of the hose connections of the present invention in contrast to fixed tube connections. As only the pathways created for the respective connections need to be discharged, the consumption of water, cleaning agent and energy will be reduced compared to connections with fixed tube connections. In addition, only short tank outlets are needed, which leads to a reduced formation risk of quality-reducing substances.

For cleaning purposes, the tanks T are connected to the CIP return flow line 3 in the same way as for the integration of target tanks in a filling pipe such as 1a. As described above in an exemplary way, any tank groups can be established in a flexible manner by means of hoses. After creating the desired tank grouping, a program, e.g. to rinse or clean pipes/hoses as well as, for example, for filling or emptying, can be started. No dismantling or installation of hose connections or other linking elements is required in the course of the program, so that no contamination due to handling of hoses or other linking elements can occur. Maximum flexibility is ensured with regard to the order in which the existing tanks can be operated for filling or emptying as the tanks can be connected in any grouping to filling, emptying and CIP return flow pipes by means of the hose connections.

In particular, n tanks can be connected directly to emptying pipes (one emptying line) and filling pipes (one filling line) by means of n+1 hoses. As soon as the connection is established, the pipes including the hoses can be rinsed, cleaned, disinfected or sterilized (and preferably be vented simultaneously in the process), and the actual transfer process of products from the tanks and/or into the tanks can run without any disconnection and/or venting of the connections. An automated discharge (displacement of a product by means of water or vice versa) is possible during the transfer process. Likewise, automated switching from one connected tank to another connected tank is possible. After finishing the transfer process, a rinsing or cleaning program can still take place without disconnecting and/or venting any connections. No manual reconnection works are required during the transfer process and a preceding cleaning/sterilization process and/or subsequent rinsing or cleaning process. Hence, the hose connections particularly do not have to be disconnected between a CIP process or a rinsing process and a transfer process and established again in a new position. All switching, venting and discharge processes can be run in a fully automated way. Special hose storage or cleaning stations as well as disinfection basins for hose fittings are not required in principle.

By means of the connection system according to the invention, different processes can be implemented successively in case of hose connections that have once been established as described above and not modified. In the following, an exemplary, fully automated program sequence will be described with further reference to the drawing figure. The drawing figure thereby shows only a part of the used hose connections. The exemplary program sequence comprises the following program steps: rinsing of the pipes including the hoses, filling of one or several tanks, yeast harvest, hosing, emptying of one or several tanks, rinsing and cleaning (cleaning-in-place) of pipes, hoses and tanks.

At first, pipes and hoses are vented by means of de-gassed water. The pipes can comprise a wort line, Schlaucher beer line, yeast line, unfiltered beer line, etc. The respective pipe is rinsed with de-gassed water together with the hoses that are connected to the pipes in order to vent them. The shut-off valves 22 on the hose junctions are open during this process. During rinsing of a filling pipe 1a, 1b, the shut-off valve is open to the gully 23 and the one to lock the pipe 24 is closed. The wort line 1a is rinsed with water from the brewhouse and the Schlaucher beer filling pipe 1b from the emptying side 2c. To rinse an emptying pipe 2a, 2b, 2c, the water valve 25 of the respective pipe is opened. Emptying into a gully occurs on the respective end of the emptying pipe, i.e. for example in the yeast cellar, filter cellar or at the end 26c of the Schlaucher beer filling pipe 1b. The rinsing step ends with the outflow of a target quantity of rinsing fluid, as a function of the formula and the input mode, that is measured for example via an inductive flow meter (not displayed) in the emptying pipes and/or in the brewhouse (wort). The respective target quantity of rinsing fluid is composed of a formula value for the respective volumes of the fixed tubes and the volumes of the hoses used.

As an alternative for the inductive flow meter (IFM), the respective target quantity of rinsing liquid can also be determined with another flow meter. Furthermore, a determination based on the time or by means of another meter that records turbidity or another physical property would be possible. In principle, every process that can distinguish the phase boundary of water and product is suitable. For the sake of simplicity, only the IFM is mentioned in the further description; the invention, however, is not limited to this measurement principle.

Then, filling, for example with wort, can take place. The connected target tank(s) 7 and 11 is/are filled in a determined order through the filling pipe 1a and the hoses 5, 9, 28 that are integrated in this pipe. The shut-off valves 22 on the hose junctions 4, 10 are open in this process. At first, water is displaced from the pipe and the hoses by means of wort from a brewhouse to gully 23. The shut-off valves 30a, b on the tank coupling points are thereby open and the tank valves 31a, b are closed. The shut-off valve on gully 23 is open and the one to shut off the pipe 24 is closed. After the outflow of the target discharge quantity up to the respective tank 7 (formula value plus volume in hoses 5, 9, 28, see above), measured based on the IFM of the source unit (as, for example, of the brewhouse), the respective tank valve 31a is opened and the shut-off valve 30a on the hose junction of the tank is closed.

At the end of the filling process, the product (the wort) is displaced from the source unit (for example the brewhouse) towards the respective target tank 7 by means of water. Therefore, a target discharge quantity is calculated and the shut-off valve 30a on the hose junction of the tank is opened and the tank valve 31a is closed after said target discharge quantity is achieved. The pipe 1a and the hoses 5, 9, 28 are rinsed for a certain time with water from the source unit and then the program step is finished and/or switches into a wait step. Prior to the start of the same sequence of steps for the next filling process of the next tank 11 with the next discharge process according to the preselection, the correct connection and valve position for the filling process of this tank shall be confirmed by the operator where required.

Next, the yeast harvest program can be run. By means of a yeast harvest pump from the integrated source tank(s), harvesting into the yeast cellar takes place via the yeast harvest pipe 2a and the hoses connected in this pipe. The shut-off valves on the hose junctions are thereby open. At first, water is displaced to the gully in the yeast cellar out of the pipe and the hoses by means of yeast from the first source tank whose tank valve is open. The shut-off valves on the tank coupling points are open and all other tank valves are closed during this process. After the outflow of the target discharge quantity from the respective source tank to the yeast cellar, measured based on the IFM of the yeast harvest line, a switching process to the tank mode takes place in the yeast cellar. After undercutting the turbidity target value, the water valve of the yeast harvest pipe is opened and the source tank valve is closed and hence the yeast is displaced towards the yeast cellar by means of water until the target discharge quantity is reached. The pipe and the hoses are rinsed with water out of the Schlaucher beer emptying pipe for a certain time. Then, the water valve shuts and the program is ended and/or switches into a wait step. Before the same sequence of steps for yeast harvest starts out of the next tank according to the preselection, the correct connection and valve position for the harvest of the yeast out of this tank shall be confirmed by the operator where required.

Subsequently, the program of the transfer of the Schlaucher beer (Schlauchen) can be run. Emptying of the integrated source tank(s) into the integrated target tank(s) in the defined order takes place by means of a Schlaucher beer pump via the Schlaucher beer emptying and filling pipe as well as the hoses that are integrated in these pipes. The shut-off valves on the hose junctions are open in this process. At first, water from the pipe and the hoses is displaced by means of Schlaucher beer from the first source tank, whose tank valve is open, to the gully of the Schlaucher beer filling pipe. The shut-off valves on the tank coupling points are open during this process, and all remaining tank valves are closed. The shut-off valve on gully is open and the one to shut the pipe is closed.

After the outflow of the target discharge quantity from the respective source tank to the respective target tank, measured based on the IFM of the Schlaucher beer emptying pipe, the respective target tank valve is opened and the shut-off valve on the hose junction of the tank is closed. If the source tank is emptied during the hosing process, the system will switch to the next source tank according to the preselection after the operator has confirmed the correct connection and valve position for hosing from this tank where required. If the target tank is filled completely during hosing, the system will switch to the next target tank according to the preselection after the operator has confirmed the correct connection and valve position for hosing into this tank where required. In case of an empty signal of the last source tank according to the preselection, the water valve of the Schlaucher beer emptying pipe is opened and the source tank valve is closed and hence the Schlaucher beer is displaced towards the target tank by means of water. After achieving the target discharge quantity, the shut-off valve on the hose junction of the target tank is opened and the tank valve is closed. The pipe and the hoses are rinsed by means of water out of the Schlaucher beer emptying pipe for a predefined time. Then, the water valve shuts and the program is ended.

The emptying program can be operated subsequently. For example, unfiltered beer can be conveyed out of a tank into a filter system. Product (unfiltered beer) is/are conveyed from the integrated source tank(s) 16, 20 to the filter system by means of a beer pump via the emptying pipe 2b as well as the hoses 14, 18, 32 integrated in the pipe. The shut-off valves 34 on the hose junctions 13, 19 are open during the process. At first, water is displaced from the pipe 2b and the hoses 18, 32 by means of product (unfiltered beer) from the first source tank 16, whose tank valve 35a is open, to the gully of the target systems (for example the filter cellar). The shut-off valve 36b on the tank coupling point 21 is thereby open and the shut-off valve 36a on the tank coupling point 15 is closed, and all remaining tank valves 35b are closed. After the outflow of the target discharge quantity from the respective source tank 16 to the filter cellar, measured based on the IFM of the emptying pipe 2b, switching to product inflow takes place in the target system.

If the source tank 16 becomes empty during the emptying process, the system will switch to the next source tank 20 according to the preselection after the operator has confirmed the correct connection and valve position for the emptying process of this tank where required. In case of an empty signal of the last source tank 20 according to the preselection, the water valve 25 of the emptying pipe 2b is opened and the source tank valve 35b is closed and hence the product is displaced towards the target unit by means of water until the target discharge quantity is reached. Afterwards, the water valve 25 will shut and the program will be finished.

Rinsing of the pipe including the hoses with hot water and/or a disinfection agent from a CIP system can take place as a next program. A filling and/or emptying pipe as well as the hoses integrated in this/these pipe(s) is/are sterilized by means of hot water and/or disinfection agent, possibly through integration of pipes of source units and/or towards target units via the CIP system. The shut-off valves on the hose junctions are open during this process. In the filling lines, the shut-off valve is closed to gully (and is timed where appropriate) and the valve to shut the pipe is open. The valves to shut the CIP flow on the emptying lines are open, the associated shut-off valves for the leakage drain are closed and timed where appropriate. The seat lifting gears (if double-seat valves are used) on the tank valves that are connected in the loop by means of hoses are lifted in the respective media steps.

In the following, a CIP process for the pipes and hoses can be run. A filling 1a and/or emptying pipe 2b as well as the hoses 5, 9, 28 / 14, 18, 31 integrated in this/these pipe(s) is/are are cleaned by means of caustic solution, acid, water and, where appropriate, hot water and/or disinfection agent, possibly with the integration of pipes from source units and/or towards target units via the CIP system. The shut-off valves 22/34 on the hose junctions 4, 10 / 13, 19 are open during this process. In the filling line 1a, the shut-off valve is closed to gully 23 (and timed where appropriate) and the valve to shut the pipe 24 is open. The valves to shut the CIP flow on the emptying pipes 37 are opened, the associated shut-off valves for the leakage drain 38 are closed and timed where appropriate. The seat lifting gears on the tank valves 31/35 (if they are designed as double-seat valves), that are integrated in the loop by means of hoses 5, 9, 28 / 14, 18, 32, are timed in the respective media steps.

Subsequently, the program of a tank CIP can be run. One or several tanks are cleaned from the CIP unit by means of the CIP return flow pipe with a pump and the hoses integrated therein. The shut-off valves on the hose junctions are open during this process. Several tanks can be cleaned successively if it is ensured that, during cleaning of one tank, the riser line(s) of the remaining tank(s) are not connected or connected in a leakage-proof way to the CIP flow. Before the cleaning process of a defined tank can start automatically, the correct connection and valve position for the cleaning process of this tank shall be confirmed by the operator where appropriate.

1. Tank connection system comprising:
a tank
a plurality of tanks (T);
each one of the plurality of tanks (T) having a tank outlet (0) to which a duct element (L), which has a first hose junction on a first end and a second hose junction on a second end, is connected via a first valve; and
a plurality of pipes that respectively have two further hose junctions that can one of be shut off from each other by means of a second valve, or be disconnected from each other through a line break.

2. The tank connection system according to claim 1 in which the first valve is an automated leakage-proof valve.

3. The tank connection system according to claim 1 in which the second hose junction of the duct element (L) is equipped with an automated shut-off valve.

4. The tank connection system according to claim 1 in which the plurality of pipes comprise at least one filling pipe to fill at least one of the plurality of tanks (T) and at least one emptying pipe to empty at least one of the plurality of tanks (T).

5. The tank connection system according to claim 4 in which each filling pipe has an upstream and a downstream hose junction as the two further hose junctions and comprises a combination of a drain valve and a block valve downstream of the downstream hose junction.

6. The tank connection system according to claim 4 in which each emptying pipe has an upstream and a downstream hose junction as the two further hose junctions and is connected to a water pipe upstream of the upstream hose junction by means of a particularly automated and leakage-proof third valve.

7. The tank connection system according to claim 6 in which each emptying pipe is connected to a cleaning-in-place system upstream of the upstream hose junction by means of the third valve.

8. The tank connection system claim 1 in which at least one of a first group of the plurality of tanks (T) is connected by means of a plurality of first hoses with a filling pipe and/or in which a second group of the plurality of tanks (T) is connected by means of a plurality of second hoses with an emptying pipe.

9. The tank connection system according to claim 1 for a brewery in which the tanks (T) comprise storage tanks and fermentation tanks.

10. A process for filling and/or emptying of tanks (T) that have respectively one tank outlet (0), which is connected to a duct element (L) between two hose junctions of said duct element by means of a first valve, comprising:
at least one of
a) connecting a group of target tanks of the tanks (T) to at least one filling pipe (1a) that has two filling pipe hose junctions, which can be shut off from each other by means of a second valve or that are disconnected from each other by means of a line break, by means of a first plurality of hoses, the connecting including linking one of the two hose junctions to one of the two filling pipe hose junctions by means of hoses of the first plurality of hoses; or
b) connecting a group of source tanks of the tanks (T) to at least one emptying pipe that has two emptying pipe hose junctions, which can be shut off from each other by means of a second valve or that are disconnected from each other through a line break, by means of a second plurality of hoses, the connecting including linking one of the two hose junctions to one of the two emptying pipe hose junctions by means of hoses of the second plurality of hoses;
and after finishing the connecting of the group of target tanks or of the group of source tanks,
c) at least one of filling of the group of target tanks with a product emptying of the group of source tanks without disconnecting a hose connection.

11. The process according to claim 10, and connecting the target tanks further comprises interconnection the target tanks by means of hoses from the first plurality of hoses.

12. The process according to claim 10, and transferring a product is from a source tank into a target tank.

13. The process according to claim 10, further comprising, after finishing the connection of the group of target tanks or the group of source tanks and prior to filling and emptying:
rinsing with water, at least one of the at least one filling pipe, the at least one emptying pipe, hoses of the first plurality of hoses (5, 9, 28) and/or hoses the second plurality of hoses, without disconnecting the hose connection.

14. The process according to claim 13, further discharging the rinsing water of the at least one filling pipe, the at least one emptying pipe, the hoses of the first plurality of hoses, and/or the hoses of the second plurality of hoses after finishing the rinsing process, without disconnecting any hose connection.

15. The process according to claim 10, further comprising cleaning of one or more of the at least one filling pipe, the at least one emptying pipe, of hoses of the first plurality of hoses, the second plurality of hoses after at least one of finishing the filling or the emptying process by means of a connected cleaning-in-place system, without disconnecting any hose connection.

16. The process according to claim 10, further comprising cleaning one or successively multiple ones of the tank(s) (T) after finishing the filling and/or emptying process by means of a connected cleaning-in-place system, without disconnecting any hose connection.

17. The process according to claim 10, and connecting the source tanks comprises interconnecting the source tanks by means of hoses from the second plurality of hoses.

18. The process according to claim 11, and connecting the source tanks comprises interconnecting the source tanks by means of hoses from the second plurality.
